(19) United States
(12) Patent Application Publication
(10) Pub. No.: US 2020/0318391 A1
(43) Pub. Date: Oct. 8, 2020

(54) straight shank adjustable combination lock

(71) Applicant: Rogers Joseph Selander, Kingsland, GA (US)

(72) Inventor: Rogers Joseph Selander, Kingsland, GA (US)

(21) Appl. No.: 16/355,945

(22) Filed: Apr. 8, 2019

(51) Int. Cl. E05B 37/02

(52) U.S. Cl. CPC E05B 37/02

(57) ABSTRACT

The invention is a straight shank combination lock that includes a straight shank and a lock assembly, which, during use, lie between a chain or other device being secured to prevent the shank from being cut.

### BACKGROUND

### Field of the Invention

This invention is related to locks, and more specifically to adjustable combination locks for securing multiple cables, chains, or the like.

### Description of the Related Art

There are existing locks being used by the public to secure items such as chain binders. Conventional U-shaped locks include a shank that is exposed. Exposure of the shank allows criminals and other to compromise the lock by cutting it. There are closed shank locks as well. However, closed shank locks can only secure one or two chains or cables at a time, which limit their use.

What differentiates the present invention is that it is a single shank lock wherein the shank is protected by the object being secured. Since the shank is protected and not exposed it can't be easily cut by those seeking to remove it.

### SUMMARY

The present invention is an adjustable combination lock that includes at least one straight shank and a detachable lock assembly, the straight shank includes a shaft having a first and a second end, at least one lock key disposed between the two ends, and a shank head attached to the first end of the shaft; the detachable lock assembly has a first end cap with an aperture therethrough, a second end cap with an aperture therethrough and an end cap with a diameter that is the same as the first end cap, a plurality of tumblers disposed between the end caps, the tumblers each having a diameter that is less than the diameter of the first end cap and the second end cap, said tumblers having a lock key hole therethrough adapted for communication with said at least one lock key, an incomplete cylindrical casing having a first end permanently attached to more than 50% of a side portion of the first end cap and a second end permanently attached to more than 50% of a side portion of the second end cap, and at least one circular spacer disposed between and in rotational communication with at least one long side of at least one spacer, said at least one spacer having a diameter that is less than the diameter that is less than the diameter of the first end cap and the second end cap, the at least one spacer comprising an aperture therethrough, whereby the plurality of tumblers and the at least one spacer alternate between said first end cap and said second end cap, and whereby the first end cap and the second end cap are unable to rotate.

### BRIEF DESCRIPTION OF THE DRAWINGS

FIG. 1: is a side, cut-out view of one embodiment of the combination lock of the invention with the casing removed.

FIG. 2: is a side view of a one embodiment of the shank of the invention.

FIG. 3A: is a side view of one embodiment of an end cap of the invention.

FIG. 3B: is a front view of one embodiment of an end cap of the invention.

FIG. 4A: is a front view of one embodiment of a keyed tumbler of the invention.

FIG. 4B: is a side view of one embodiment of a keyed tumbler of the invention.

FIG. 5A: is a front view of one embodiment of a spacer of the invention.

FIG. 5B: is a side view of one embodiment of a spacer of the invention

FIG. 6A is a front view of one embodiment of a casing of the invention.

FIG. 6B is a side view of one embodiment of a casing of the invention.

FIG. 7 is an illustrative perspective view showing use of one embodiment of the adjustable combination lock of the invention to secure a chain.

### DETAILED DESCRIPTION

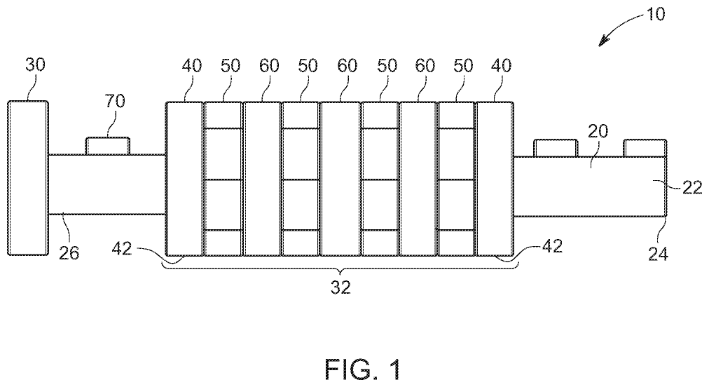

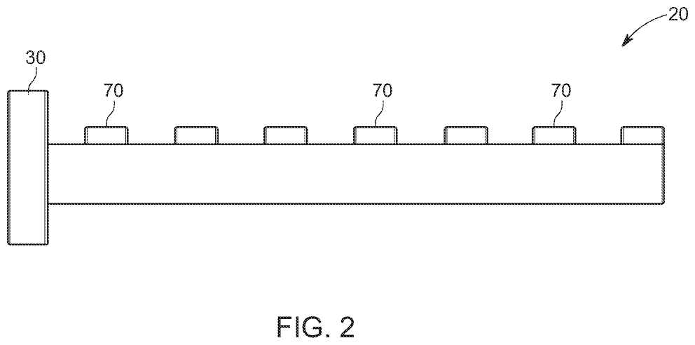

With reference to FIG. 1, and in one embodiment of the invention, an adjustable combination lock 10 is provided that includes a straight shank 20 and detachable combination lock assembly 32. Lock assembly 32 is detachably attached to shank 20 so that assembly 32 may be removed and reattached during use.

Lock assembly 32 comprises first end cap 40 and second end cap 40, each disposed at opposite ends of lock assembly 32 and each comprising aperture 110, adapted to removably accept and attach to shank 20. Lock assembly 32 further comprises at least one spacer 60 and a plurality of keyed tumblers 50, each disposed between first end cap 40 and second end cap 40 in an alternating pattern. Each keyed tumbler 50 (“tumblers”) has a diameter that is less than the diameter of first end cap 40 or second and cap 40. Lock assembly further comprises an incomplete cylindrical casing 140 permanently attached to each end cap 40 such a user only has access to a portion, outside edge 52, of each tumbler 50.

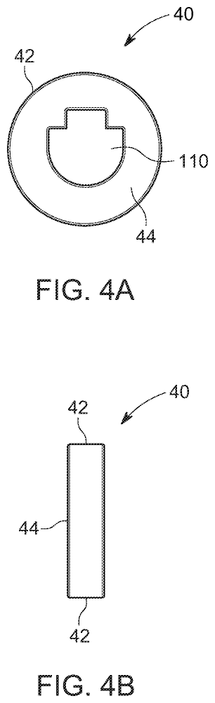

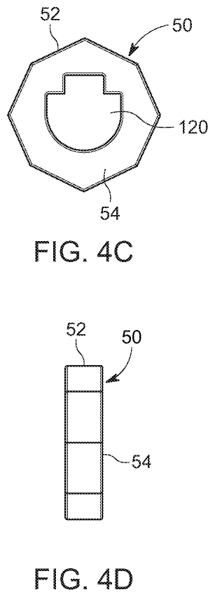

Keyed tumblers 50 are disposed between end caps 40 and are each separated by spacers 60. With reference to FIGS. 1, 4A and 4B, keyed tumblers 50 are generally octagonal in shape. Those of skill in the art will recognize that tumblers 50 may be other shapes, so long as the shapes have at least one flat surface, allowing a user to select an identifier which is written on each side of tumblers 50. Tumblers 50 include an inside edge 54 adapted for rotational contact with at least one spacer 60 and in some instances end cap 40. Tumbler 50 includes an aperture or lock key hole 120 therethrough. Key hold 120 allows shank 20 to fit therewithin and is adapted to fit onto shank keys 70, which are disposed about shank 20. Tumblers 50 also includes an outside edge 52, which is adapted to allow a user to select a unique identifier or symbol, which is about the surface of edge 52. Lock assembly 32 comprises tumblers 50, which may each be different from one another, although duplicate tumblers 50 may also be employed. Each tumbler 50 has a keyhole 120 with a central plane that is different with reference to each side of tumbler 50. Having different tumblers 50 allows the combination locks to have different combination codes.

Any number of tumblers 50 and spacers 60 may be employed within lock assembly 32, so long as there are a plurality of tumblers 50. In one embodiment of the invention, between two and seven tumblers 50 are employed. Accordingly, between one and six spacers 60 are employed.

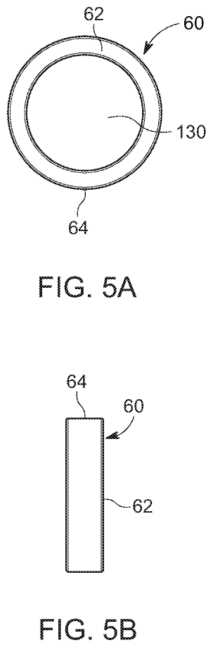

Spacers 60 are in rotational communication with each tumbler 50. With reference to FIGS. 5A and 5B, spacers 62 are generally circular shaped with an aperture 130 centrally located therewithin. Each spacer 60 has a two inside edges 62, each in rotational communication with keyed tumblers 50. Spacer 60 also include an outside edge 64, which is adapted to allow a user to rotate spacers 60. Spacer 60 has a diameter that is less than the diameter of end caps 40.

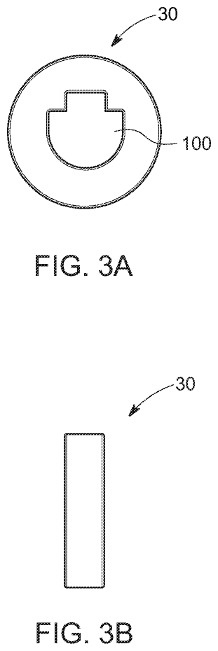

With reference to FIGS. 1, 3A and 3B, end caps 40 comprise an outside edge 42, inside edge 44 and an aperture therethrough 110, which is generally the same shape as aperture 120 of the tumbler. Other shapes may be employed, however. End caps 40 are disposed at opposite ends of lock assembly 32 and have a diameter which is less than the diameter of spacer 60 and tumblers 50. End caps 40 are stationary and can't be moved by a user. Inside edge 44 is in communication with tumblers 50, which do rotate about shank 20.

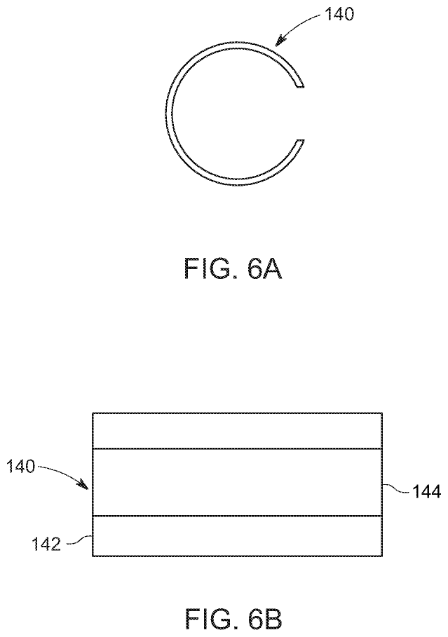

With reference to FIGS. 6A and 6B, lock assembly 32 further comprises casing 140, which has a first end 142 and a second end 144, each disposed about opposite ends of casing 140. Casing 140 is an incomplete cylinder, which is permanently attached to end caps 40 at first end 142 to end cap 40 and at first end 144 to second end cap 40. First end 142 is attached to no more than 50% of outside end 42 of first end cap 40 and second end 144 is attached to no more than 50% of outside end 42 of the second end cap 40. Any means for permanently attaching casing 140 to end caps 40 may be used, including welding. An aperture exists with casing 140 to accept the plurality of tumblers 50, spacers 60 and end caps 40. With specific reference to FIG. 6A, casing 140 includes a space to allow access to edge 52 of tumblers 50. Allowing space is integral to the function of lock 10, as it allows a user to select a combination by rotating tumblers 50. The access space must be less that 50% of the body of the cylinder. As is obvious to those of skill in the art, the size of casing 140 is dependent upon the number and size of tumblers 50 and spacers 60 employed in the lock assembly 32. The size of combination lock assembly 32, and consequently tumblers 50, spacers 60 and end caps 40 is dependent upon the size and shape of the item to be locked or secured.

In a specific embodiment of the invention, the access space is about equal to one side of tumblers 50. In a more specific embodiment of the invention tumblers 50 are octagonal and the access space is equal to about ⅛th of the body of the cylinder. End caps may be of any size, so long as they have a diameter that is larger than the diameter of either spacer 60 or tumblers 50. If end caps 40 have the same diameter as spacer 60 or tumblers 50, casing 140 would prevent rotation of tumblers 50 rendering lock 10 unusable.

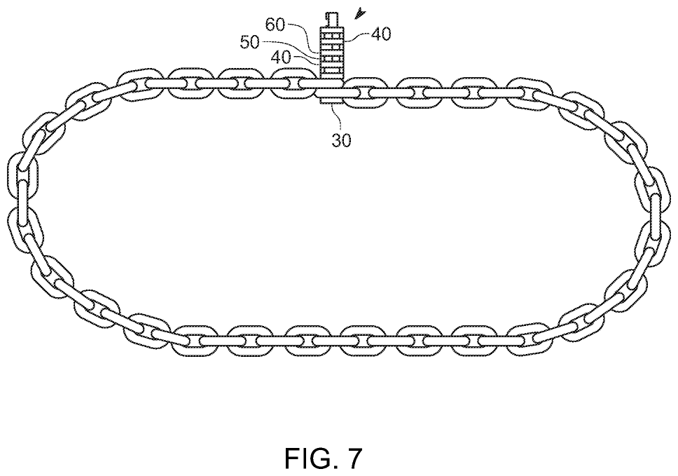

Shank 20 comprises one end 24 and second end 26, each being disposed at opposite ends of shank 20. Shank head 30 is attached to second end 26 and has a diameter that is larger than the aperture of the device it is being used to lock. For example, and with reference to FIG. 7, if lock 10 is being used to secure two ends of a chain, shank head 30 must have a diameter that is larger than the chain's aperture. Shank 70 comprises lock keys 70, which are disposed about an outer surface of shank 20 between first end 24 and second end 26. Keys 70 are adapted for flush communication with lock key hole 120 of keyed tumbler 50. The inside diameter of lock key hole 120 is approximately the same shape and size as the outside shape and size of keys 70.

To secure multiple cables or chains, and with reference to FIG. 7, one must insert shank 20 though the spaces between the chain or cable at either end so that shank head 30 abuts the end of the chain, end 26 is within the spaces of the cable or chain, and end 24 is exposed and outside of the chain or cable. Once shank 20 is inserted through the item, lock assembly 32 is then slid over end 24 and shank 20 so spacer 42 is against the chains or cable and a small portion of end 24 is exposed. Lock assembly 32 is then turned to secure the lock onto shank 20. Shank head 30 stops the combination lock from sliding through the chain or other device being secured.

To attach lock assembly 32 to shank 20, a user must rotate tumblers 50 and end caps 40 so that lock key holes 120 and apertures 110 are aligned with keys 70 about shank 20. Alignment occurs when a user has positioned the unique identifiers or symbols about tumblers 50 in a manner that corresponds with the combination lock code. Once lock assembly 32 is placed around shank 20, tumblers 50 are rotated to conceal the code. The described lock 10 is unique in that shank 20 is hidden and cannot be compromised. One desiring to cut shank 20 are prevented from doing so due to the presence of lock assembly 32 and the device being locked.

Any heavy-duty metal may be used to make lock 2. In a preferred embodiment lock 2 is made of steel. Modifications and variations of the lock 10 described are anticipated and within the scope of this invention.

1. An adjustable combination lock comprising:
at least one straight shank comprising
a shaft having a first end and a second end,
at least one lock key disposed about the shaft between the first end and the second end, and
a shank head attached to the first end of the shaft; and
a detachable lock assembly comprising
a first end cap having an aperture therethrough,
a second end cap having an aperture therethrough, said second end cap having a diameter that is the same as the first end cap,
a plurality of tumblers disposed between the first end cap and the second end cap, said tumblers each having a diameter that is less than the diameter of the first end cap and the second end cap, said tumblers having a lock key hole therethrough adapted for communication with said at least one lock key,
an incomplete cylindrical casing having a first end permanently attached to more than 50% of a side portion of the first end cap and a second end permanently attached to more than 50% of a side portion of the second end cap, and
at least one circular spacer disposed between and in rotational communication with at least one long side of at least one spacer, said at least one spacer having a diameter that is less than the diameter that is less than the diameter of the first end cap and the second end cap, the at least one spacer comprising an aperture therethrough,
whereby the plurality of tumblers and the at least one spacer alternate between said first end cap and said second end cap, and
whereby the first end cap and the second end cap are unable to rotate.

2. The adjustable combination lock of claim 1 wherein said tumbler has an outer octagonal shape.

3. The adjustable combination lock of claim 1 comprising between two and seven tumblers.

4. The adjustable combination lock of claim 2 wherein said tumblers each comprise lock key holes that are positioned differently with regard to said outer octagonal shape.

5. The adjustable combination lock of claim 1 wherein the lock is made of metal.

6. The adjustable combination lock of claim 1 wherein the metal is steel.

7. The adjustable combination lock of claim 1 wherein said tumblers are each uniquely marked with at least one symbol.

8. An adjustable combination lock comprising:
at least one straight shank comprising
a shaft having a first end and a second end,
at least one lock key disposed about the shaft between the first end and the second end, and
a shank head attached to the first end of the shaft, wherein the shaft is made of steel; and
a detachable lock assembly comprising
a first end cap having an aperture therethrough,
a second end cap having an aperture therethrough, said second end cap having a diameter that is the same as the first end cap,
between two and seven tumblers disposed between the first end cap and the second end cap, said tumblers each having a diameter that is less than the diameter of the first end cap and the second end cap, said tumblers having a uniquely positioned lock key hole therethrough adapted for communication with said at least one lock key, and said tumblers each being uniquely marked with at least one symbol,
an incomplete cylindrical casing having a first end permanently attached to more than 50% of a side portion of the first end cap and a second end permanently attached to more than 50% of a side portion of the second end cap, and
at least one circular spacer disposed between and in rotational communication with at least one long side of at least one spacer, said at least one spacer having a diameter that is less than the diameter that is less than the diameter of the first end cap and the second end cap, the at least one spacer comprising an aperture therethrough,
whereby the plurality of tumblers and the at least one spacer alternate between said first end cap and said second end cap, and
whereby the first end cap and the second end cap are unable to rotate.
